(19) United States
(12) Patent Application Publication
(10) Pub. No.: US 2011/0114618 A1
(43) Pub. Date: May 19, 2011

(54) UNIVERSAL FOOD HOLDING CABINET WITH SNAP-IN ESCUTCHEONS

(75) Inventors: TERRY TAE-IL CHUNG, BARTLETT, IL (US); MICHAEL VALENTINO, GENEVA, IL (US); EDWARD EATON, EOLA, IL (US); ERIC LARSON, PECATONICA, IL (US); BRIAN W. MATHEWS, WATERMAN, IL (US); KERRY BERLAND, CHICAGO, IL (US); DOUGLAS REINKING, CHICAGO, IL (US)

(73) Assignee: PRINCE CASTLE, INC, CAROL STREAM, IL (US)

(21) Appl. No.: 12/618,939

(22) Filed: Nov. 16, 2009

(51) Int. Cl. H05B 1/00; F27D 11/00

(52) U.S. Cl. 219/201; 219/385

(57) ABSTRACT

Bezels or escutcheons for a temperature-controlled food holding cabinet are removable and field replaceable by the use of interlocking tabs and detents that hold the escutcheon in place and align the escutcheon to electrical connectors. A tab formed on either the escutcheon or chassis of the cabinet, engages a corresponding detent formed on either the cabinet chassis or the escutcheon. Two tabs and detents are preferably used. One tab engages a corresponding detent with an interference fit.

### BACKGROUND

Many restaurants' success depends on how quickly customers can be served with food items that a customer orders. If the rate at which a restaurant cooks food products equals the rate at which those same food products are being ordered and sold, a fast food restaurant can theoretically have freshly-cooked foods ready to serve for customers as they arrive. Since it is not always possible to match cooked-food production with customer ordering rates, and since fast food restaurant customers expect to receive their ordered food items quickly, many fast food restaurants pre-cook various food items and keep them warm, ready for sale until a customer arrives and purchases a pre-cooked food item.

Pre-cooked food items cannot be stored for prolonged periods and must be kept warm while they are being held. Prolonged heating causes food texture and flavor to deteriorate. The time that a food product can be kept warm yet remain palatable will vary with each type of food product. It is therefore beneficial to have an ability to store different types of foods at different temperatures and keep track of the time that a food has been kept warm.

Food holding cabinets are well known in the prior art. A problem with prior art food holding cabinets, as with most commercial restaurant equipment is that they sometimes fail and require a service technician to repair. In keeping with food service operators' goal of reducing cost, it would be desirable to provide on-site service ability to a food holding cabinet whereby repairs can be effectuated by a restaurant operator, on-site and without having to call a service technician.

### BRIEF DESCRIPTIONS OF THE DRAWINGS

Preferred embodiments are set forth in the following detailed description and accompanying in drawings in which like reference numerals represent like parts.

FIG. 1 is a perspective view of a universal food holding cabinet with snap-in escutcheons;

FIG. 2 is a front view of the oven depicted in FIG. 1, with the top panel removed;

FIG. 3 is a rear view of the oven depicted in FIG. 2;

FIG. 4 is a perspective view of the rear of the oven shown in FIG. 3 with the uppermost escutcheon removed from the rear face of the oven, and showing the oven's right-side panel (when viewed from the front) removed to reveal the right side of the oven chassis and attachment points of the escutcheons;

FIG. 5 is a perspective view of the front of the oven shown in FIG. 3 with the uppermost escutcheon removed from the front face of the oven, and showing the oven's left-side panel removed to reveal the right side of the oven chassis and attachment points of the escutcheons;

FIG. 6 is a close up view of one side of the chassis (left or right) showing the attachment of a snap-in escutcheon using a detent;

FIG. 7 is a perspective view of the back or rear side of a snap-in escutcheon shown in FIG. 6, and showing an electrical connector on one end;

FIG. 8 is a close-up perspective view of the back side of the snap-in escutcheon shown in FIG. 7 and the electrical connector shown in FIG. 7;

FIG. 9 is a close-up view of a left-end of one of the shelves of the holding cabinet shown in FIG. 1, with one of the escutcheons removed; and

FIG. 10 is a cross-sectional view of the holding cabinet shown in FIG. 1.

### DETAILED DESCRIPTION

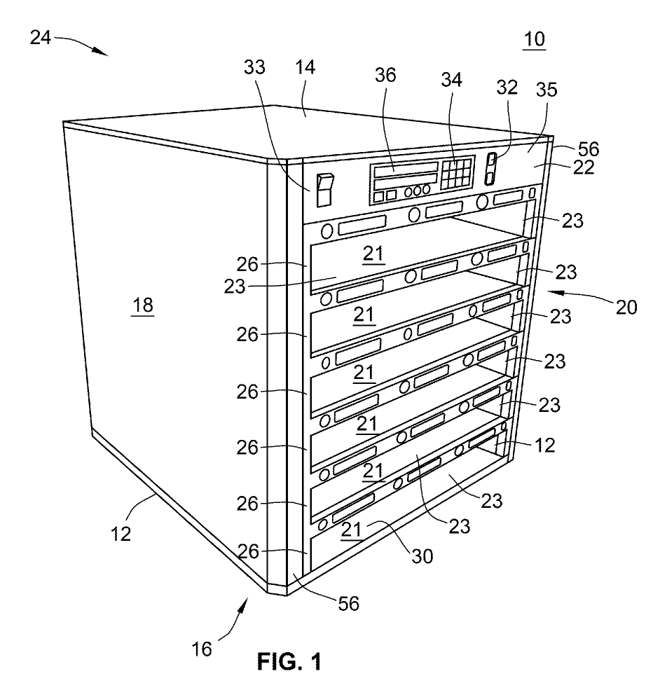

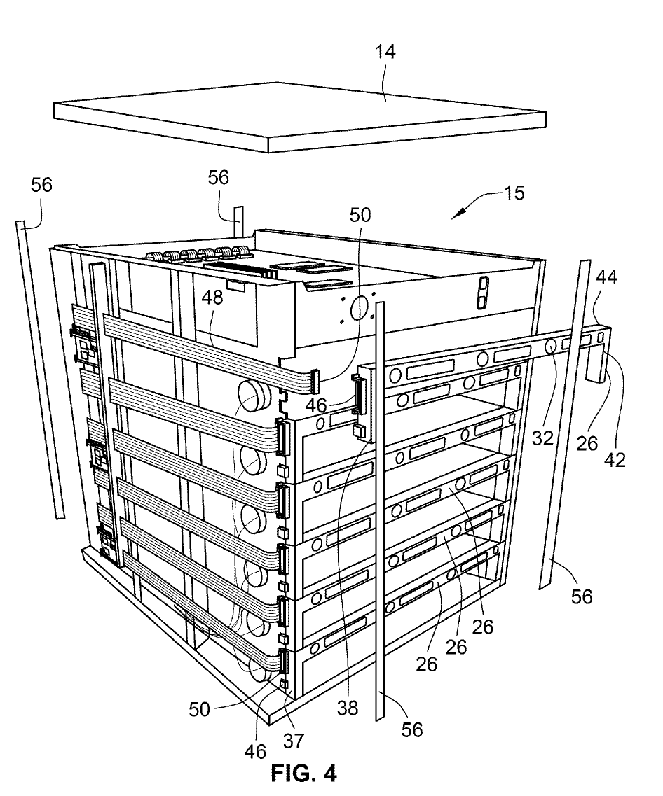

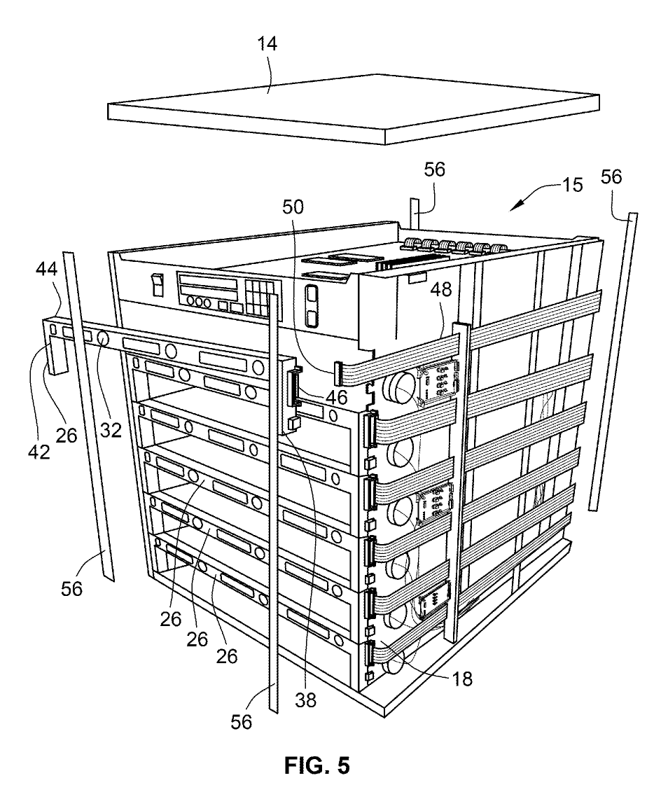

FIG. 1 is a perspective view of a temperature-controlled food holding cabinet 10. The holding cabinet 10 is comprised of a metal frame or chassis 12, best seen in FIG. 4 and FIG. 5. The chassis 12 is comprised of various stamped and/or rolled metal components that form a substantially cube-shaped oven-like cabinet subdivided into several separate, temperature-controlled food-holding compartments 23. Depending on the placement of heating and cooling elements as described more fully below, each shelf 21 is capable of maintaining one or more different temperatures for different types of food items.

As can be seen in FIG. 1, the cabinet 10 is comprised of a top panel 14, a bottom panel 16, a left-side panel 18, a right-side panel 20, a front face 22 and a rear face 24 not visible in FIG. 1. The top panel 14 covers electronic components, which include a master controller computer, cables and connectors that provide various connections between a front panel user interface and the master controller. A top panel 31 of the front face 22 provides several user interfaces by which a cabinet operator can configure the cabinet but also quickly determine its status by visually reading corresponding user interfaces. As can be seen in FIGS. 4 and 5, the side panels 18 and 20 also cover various electronic circuits and associated wiring.

The front face 22 and the rear face 24, are provided with snap-into-place bezels, which are also referred to herein as snap-in escutcheons or simply escutcheons, and which are identified in the figures by reference numeral 26. As described more fully below, the escutcheons 26 cover the edges 25 of the shelves 21. They also define openings into food storage compartments 23. And, the escutcheons 26 provide user interface devices, which include display devices and user-actuated control devices, the function and operation of which is described more fully below.

Importantly, the escutcheons 26 are used on both the front and rear faces of the cabinet 10 and are interchangeable. The escutcheons 26 are configured to have electrically parallel electrical connectors 46 at each end of the escutcheon 26, which mate with chassis-located connectors 50 described more fully below but preferably located to one side of each cabinet face.

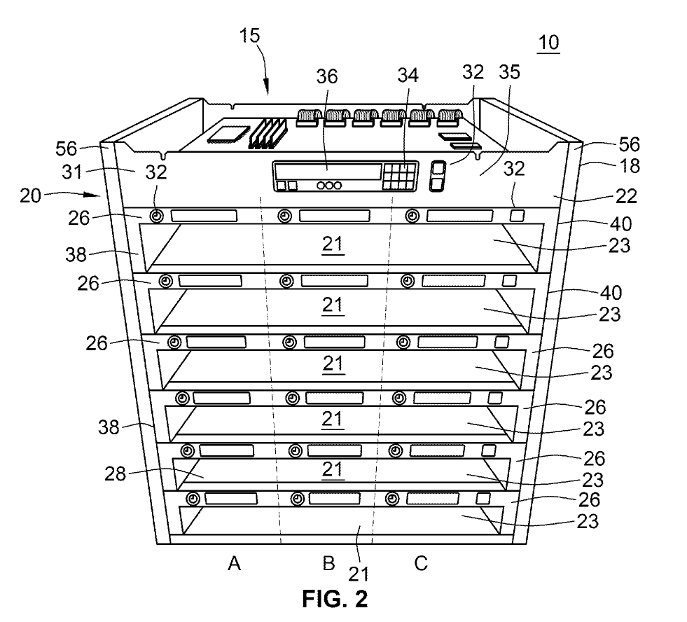

FIG. 2 is a front view of the cabinet 10 with the top panel 14 removed to reveal cabinet electronics equipment in the cabinet's electronics compartment 15, which is covered and protected by the top panel 14. The electronic equipment in the electronics compartment 15 includes at least one “master” computer/controller 70 for other electronics in the cabinet 10.

Below the electronics compartment 15 are several horizontal and substantially planar, thermally-conductive shelves 21. The shelves 21 are vertically separated from each other in the chassis 12 and fixed between the left side panel 18 and right side panel 20 to define food-holding compartments 23. The vertical separation distance between each shelf 21 defines the height of each compartment 23 and thus the maximum height of a food item or the packaging for a food item.

The shelves 21 and thus the compartments 23 are considered to extend horizontally across most of the width of the cabinet 10. The shelves 21 are preferably made from thermally conductive materials such as aluminum, copper or steel, so that the temperature of the food holding compartments 23 can be maintained by the transfer of heat from the shelf 21 into the compartment 23, or from the compartment 23 into the shelf 21. Different types of temperature control elements 50 are embedded into each shelf or otherwise thermally coupled thereto. Compartment temperature can thus be achieved by controlling the temperature of the temperature control elements 50, which in turn controls the temperature of the thermally conductive shelves 21, which define the compartments 23.

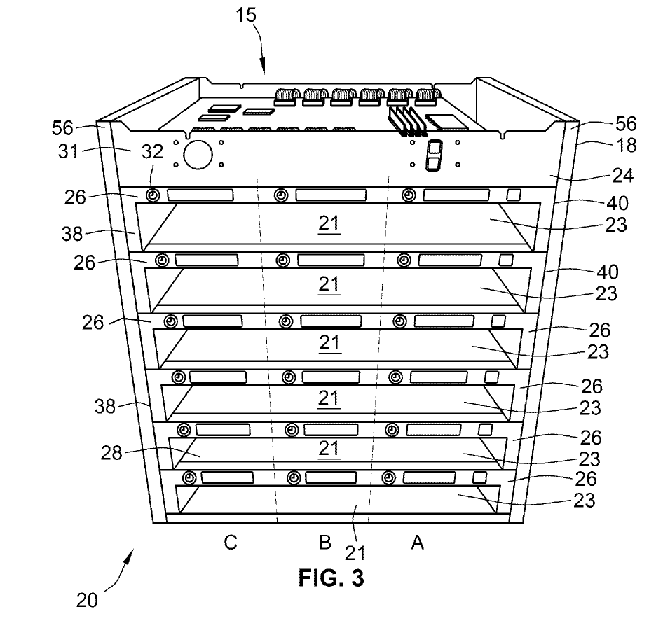

In a preferred embodiment, the shelves 21 of the cabinet 10 are subdivided horizontally into separate, temperature-controlled zones. The different zones for each shelf are identified in FIGS. 2 and 3 by the letters A, B and C. When the cabinet 10 is viewed from the front, as shown in FIG. 2, the “A” zone of each shelf is at the left-hand side of the cabinet 10; the “C” zone is locate on the right-hand side of the cabinet 10; the “B” zone is located between the A and C zones. Temperature control of the separate zones A, B and C is accomplished by using separate temperature control elements in each zone, and which are thermally coupled preferentially to one zone over the others. By way of example, zone A in a first shelf has a heater embedded in the shelf and centered in the “A” zone. It therefore provides most of its heat output into the A zone.

A heater embedded in the shelf 21 and centered in the “A” zone is separately controlled from heaters that are embedded in the same shelf 21 and centered in zones B and C and vice versa. In an alternate embodiment, zones A, B and C and corresponding embedded heaters are thermally isolated from each other using a thermal break, such as those disclosed in co-pending application Ser. No. 12/267,449 entitled, BIFURCATED HEATED TOASTER PLATEN, which is assigned to the assignee of this application. The contents of co-pending application Ser. No. 12/267,449 are incorporated herein by reference, at least with regard to heated platens and the thermal breaks disclosed therein. In yet another embodiment, the zones are isolated from each other by walls 74, which extend between the top and bottom of the compartments 23, i.e., vertically-adjacent shelves 21 that define a compartment 23 between them.

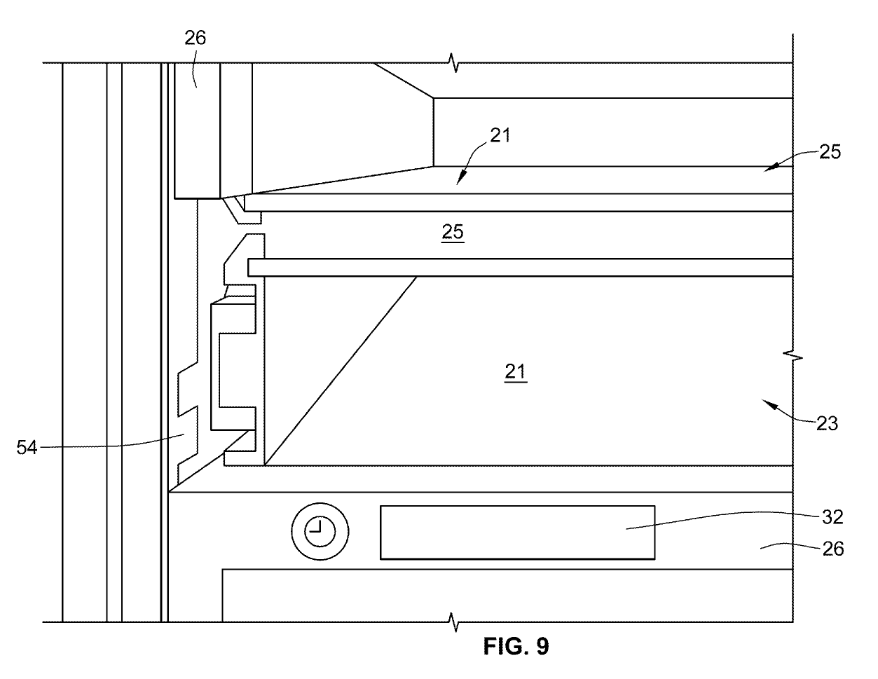

As can be seen in FIG. 9, the escutcheons 26 cover the horizontal edges 25 of the thermally-conductive shelves 21 and are formed to extend downwardly from the shelf 21 above a compartment 23 to the shelf 21 that defines the bottom of the same compartment 23. The escutcheons 26 as such thus have the shape of an inverted letter U or the symbol, n. The escutcheons 26 are therefore referred to interchangeably hereinafter as being either “U-shaped” or “inverted-U-shaped.”

Since the escutcheon assemblies 26 abut thermally-conductive shelves 21 that can be hot to the touch, the escutcheons 26 are preferably formed from a high-temperature, heat and electricity-insulating, injection-molded plastic in order to protect operators from contacting hot and cold surfaces. The escutcheons 26 can also be formed of fiberglass, carbon fiber or other suitable thermally-insulating material.

As shown in FIGS. 1-5, the escutcheons 26 extend almost completely across the width of the cabinet 10. Downward-extending or “vertical” sections at each end of the escutcheons 26 abut chassis end caps 56. The end caps 56 are attached to the front and rear faces of the cabinet 10 to fix the escutcheons 26 in place in order to prevent them from being inadvertently or accidentally removed from the chassis 12. The end caps 56 also cover and protect mating connectors in the escutcheons 26 and attached to the chassis 12.

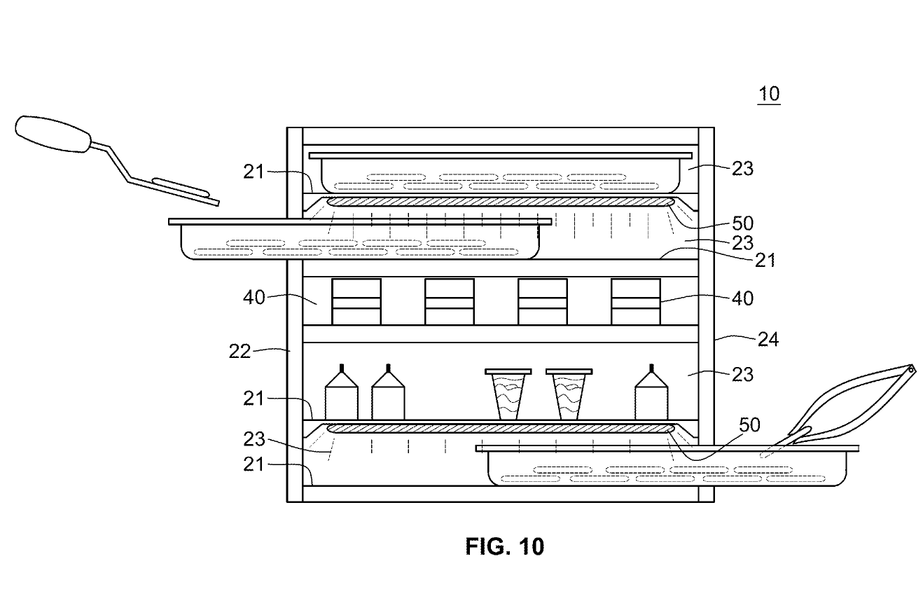

FIG. 3 is a rear view of the cabinet 10 shown in FIGS. 1 and 2; FIG. 10 is a cross-sectional view. As can be seen in FIGS. 1-3 and FIG. 10, the shelves 21 extend from the front face 22 of the cabinet 10 to the rear face 24. A food item can thus be inserted into a compartment 23 through an opening at the rear face 24 and removed through an opening at the front face 22 or vice versa.

A rectangular-shaped opening in either the front or rear of the cabinet 10 is defined by the attachment of two escutcheons 26 to vertically adjacent shelves 21. In other words, when a first escutcheon 26 is attached to either a front or rear cabinet face to cover the edge 25 of a first shelf 21, the first escutcheon 21 and a second attached to the same cabinet face to cover the edge 25 of a second shelf 21 above or below the first shelf 21, together define a rectangular-shaped “opening” in the corresponding cabinet face. In the figures, the rectangular-shaped “openings” formed by adjacent escutcheons 26 on the front face 22 of the cabinet 10 are identified by reference numeral 28. The “openings” on the rear face 24 are identified by reference numeral 30. The openings thus provide rectangular-shaped openings into the temperature-controlled food-holding compartment 23 where the temperature of food items can be maintained under they are served or discarded.

In addition to covering the edges 25 of the shelves 21 and defining openings 28 and 30 into the compartments 23, the escutcheons 26 also provide one or more user interface devices, which convey information about conditions inside the compartment, a food item inside the compartment and/or allow the input of user commands to be given to computers for a compartment. Since the escutcheons 26 are field removable and replaceable yet provide electrically-operated user interfaces as described above, the escutcheons require electrical connections that are readily “made” when an escutcheon 26 is attached to the chassis yet “opened” when an escutcheon is removed. Stated another way, electrical connectors are provided to the escutcheon 26, which engage and disengage corresponding, mating connectors in the chassis 12.

Escutcheon-located user interfaces are embodied as incandescent indicator bulbs or light-emitting diodes (LEDs) 32, various types of switches 33, liquid crystal display (LCD) panels 36, “electronic-paper” or “e-panels, various types of key pads 34 as well biometric sensors. Such devices are well-known to those of ordinary skill in the electronic arts.

Incandescent bulbs and individual LEDS can provide on/off status indicators. Seven-segment LEDs can also be configured to display alphanumeric information. LED display panels can display text and/or graphics. Electronic paper can also be used to provide text and/or graphics.

Switches used in the escutcheons 26 include toggle, push-buttons and/or rocker switches, whether illuminated or not. Keypads are also used and can be either mechanically actuated switches, capacitance-sensitive or thermally-actuated. Biometric sensors used in the escutcheons 26 include finger print readers, such as those commonly used in many personal computers.

Electronic paper, which is also known as e-paper or electronic ink, is a well known display technology that mimics the appearance of ordinary ink on paper. Unlike a conventional flat panel LCD display, which uses either a backlight or incident room light, electronic paper or e-paper reflects light like ordinary paper. It is also capable of holding text and images indefinitely without drawing electricity, while allowing the image to be changed later. The user interfaces in the escutcheons 26 an operator to configure a compartment, e.g., set a desired temperature, a food holding time etc., as well as visually determine its status.

In the preferred cabinet embodiment, wherein shelves 21 have separate temperature zones, the escutcheons 26 are configured to provide a user interface for zone A, B and C of a corresponding shelf. In FIG. 2 and FIG. 3, each escutcheon 26 has an actuator switch 32A and a display 32B for each of the three zones A, B and C. The information displayed on a particular display 32B corresponds to the zone immediately below the display 32A.

Each escutcheon 26 has a left end 38 and a right end 40. As can be seen in FIGS. 4-7, each escutcheon 26 also has a front side 42 and a rear side 44.

In a preferred embodiment of the cabinet 10, an escutcheon 26 can be used on either the front face 22 of the cabinet 10 or the rear face 24 of the cabinet 10. In other words, an escutcheon 26 can be removed from the rear face 24 and installed at the front face 22. In the same preferred embodiment of the cabinet 10, the electronic devices of the cabinet 10, which interface with user interfaces in the escutcheons 26, are located on only one side of the cabinet, i.e., the right side 20 of the cabinet, when the cabinet 10 is viewed from the front face 22. In order to make the same escutcheon 26 usable on both front and rear faces of the preferred embodiment of the cabinet 10, which has connectors for the escutcheon on only one side of the cabinet, both the left and rear ends of the escutcheon assembly 26 are provided the multi-conductor electrical connector(s) 46.

When an escutcheon 26 is installed on the rear face 24 of the cabinet 10 as described below, an electrical connector 46 on the left end 38 of the escutcheon 26 mates electrically and mechanically with a connector 50 located on the left side of the rear face 24 of the cabinet, which corresponds to the right side 20 of the cabinet 10 when the cabinet is viewed from the front. When the same escutcheon 26 is installed on the front face 22 of the cabinet 10, a connector 46 on the right end 40 of the escutcheon 26 mates electrically and mechanically with a connector 50 at the right side 20 of the front face 22 of the cabinet. Stated another way, both ends of the escutcheon are provided with the same connector 46.

In an alternate and equivalent embodiment, the cabinet 10 is configured to have a connector 50 at diagonally opposite corners. In such an embodiment, the escutcheon has a connector 46 at one of the left and right ends that mates with a corresponding connector 50 attached to the chassis at diagonally opposite corners.

As can be seen in FIG. 2, information displayed on the front face 22 of the cabinet 10 for zone A of a particular shelf 21, will be displayed on the left-most display panel 32A, when the cabinet 10 is viewed from the front. And, as can be seen in FIG. 3, information displayed on the rear face 24 of the cabinet 10 for the same zone of the same shelf 21 will be displayed on the right-most panel 32A, when the cabinet is viewed from the rear.

Whether the cabinet 10 is configured with the connectors 50 on the same, one side or at diagonally opposite corners, the user interfaces 32A and 32B on an escutcheon 26 are associated with the same zone of the same shelf 21, regardless of whether the escutcheon 26 is attached to the front face 22 or rear face 24 of the cabinet 10. In other words, when an escutcheon 26 is attached to the rear face 24, the user interface on the right-hand side of the escutcheon 26 pertains to the right-hand side of the corresponding shelf; the user interface on the left-hand side of the same escutcheon pertains to the left-hand side of the corresponding shelf. When the same escutcheon 26 is attached to the front face 22, the user interface on the right-hand side of the escutcheon 26 pertains to the right-hand side of the corresponding shelf the user interface on the left-hand side of the same escutcheon pertains to the left-hand side of the corresponding shelf.

As can be seen in FIGS. 4 and 5, multi-conductor ribbon cables or wires 48 along the “right” side 20 carry electrical signals between the various escutcheon-located user interfaces and one or more controllers located on the same side of the chassis 12. In FIG. 4, the electrical connector 46 attached to the left end a rear side 44 of the escutcheon 26 makes an electrical connection with the mating connector 50 attached to the chassis 12 when the escutcheon 26 is attached to the chassis 12.

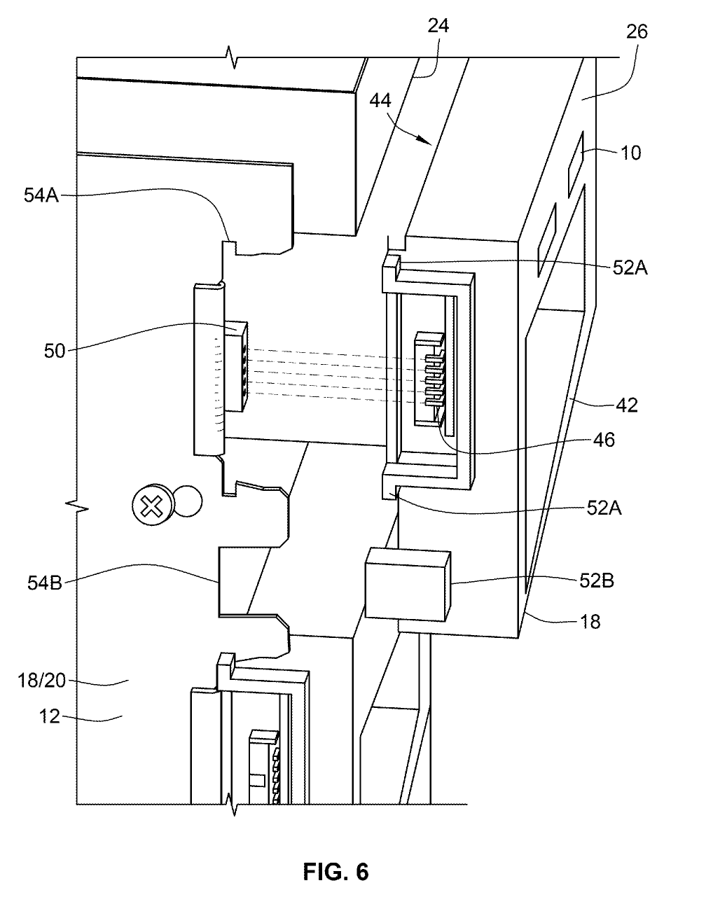

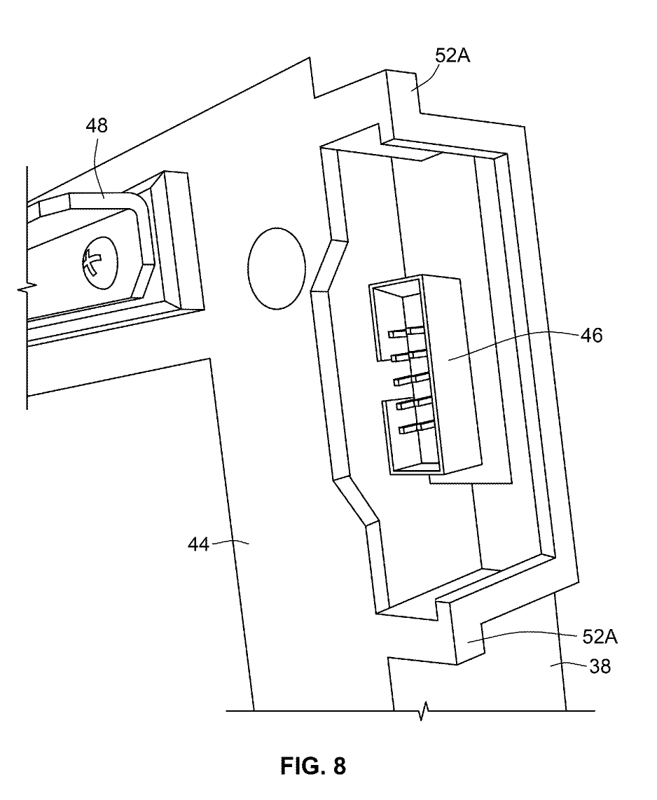

FIGS. 6, 7 and 8 reveal structures by which the escutcheons 26 are snapped into place on both the front and rear faces of the chassis 12. The escutcheons are attached to the chassis 12 by way of a mechanical and frictional engagement of a protuberance or tab 52 formed as part of the left 38 and right 40 ends of the escutcheon 26 with correspondingly mating slots or detents formed in the left 18 and right sides 20 of the chassis 12. In an alternate embodiment, a single tab (not shown) and corresponding detent (not shown) can be used at a single end of the escutcheon and chassis, or in the middle of the escutcheon and a corresponding face of the chassis.

In FIG. 6, which is an enlarged view of one side of the chassis 12 and one end of an escutcheon, a tab 52A on the end of the escutcheon 26 engages a corresponding detent 54A when the escutcheon 26 is aligned with and pushed against the rear face 24 of the chassis 12. In a preferred embodiment, the tabs 52A are sized, shaped and arranged to be just slightly larger than the corresponding detents 54A. Since the escutcheon 26 is plastic, the slightly-larger tabs 52A slightly compress and engage the corresponding detents 54A with an interference fit. The tabs 52A, and hence the escutcheon 26, thus snaps-into the detents 54A, holding the escutcheon 26 in place against the chassis and in electrical connection with the cabinet electronics. Tabs 52A are on each end of the escutcheon and engage corresponding detents on each side 18 and 20 of the chassis.

In FIG. 6, a second detent 52B is formed into the side of the chassis. The second detent 52B is deeper (projects into the cabinet sidewall) than the snap-in detent 54A.

A second tab 52B is also formed into the ends of the escutcheon. The second tab 52B is much longer (or wider) than the snap-in detents 52A. Imbuing the larger tab 52B and detent 54B with a clearance fit enables them to align the connectors 46 and 50 and align the snap-in tab 52A with the corresponding detent 54A.

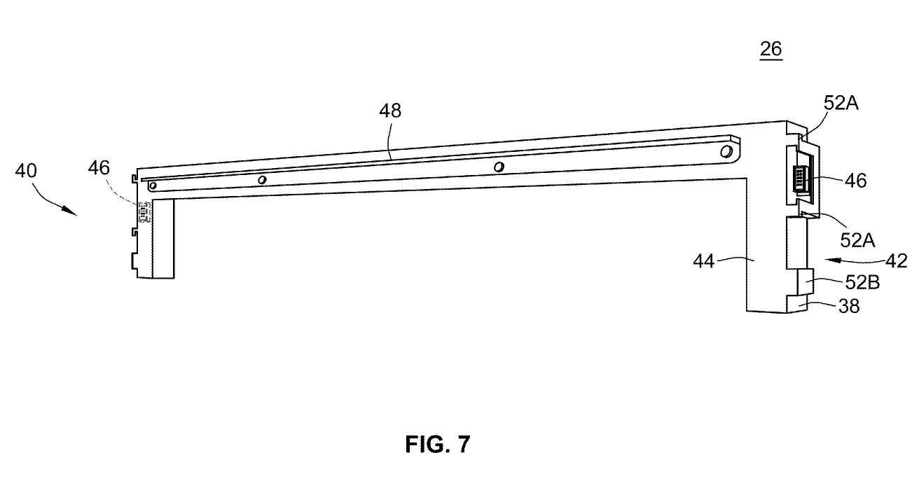

FIG. 7 shows the back or rear side 44 of the preferred embodiment of the escutcheon 26. This figure also shows the inverted U-shape of the escutcheon 26, the left-end 38 connector 46, the right end 40 connector 46, and tabs 52A and 52B. FIG. 7 also shows a stiffener bracket 48 attached to the rear side 44 by screws, used in one embodiment to strengthen the escutcheon during installation and removal from the detents.

As can be seen in the figures, the escutcheons 26 extend substantially all the way across both the front face and the rear face of the chassis 12. At both sides of the chassis, the tabs, detents and electrical connectors are concealed from view and protected from being disengaged by elongated U-shaped end caps 56 that extend vertically along both sides 18 and 20 of the cabinet 10. The end caps 56 are fastened to the chassis 12 at the left and right sides preferably using screws to hold them in place. Alternate embodiments fasten the caps 56 into place using magnets or Velcro™ fasteners.

As mentioned above, the electrical connection provided by the connectors 46 and 50 carry electrical signals between user interface devices in the escutcheons and one or more cabinet-located controllers. The escutcheon-located user interface devices described above are therefore considered to form part of the escutcheons 26. In one embodiment, the user interface display devices display information that can include either a desired temperature of a compartment 23 or an actual temperature of the compartment, the time that a food item has been inside a compartment and/or the time that a food item should remain in a compartment, the identity of a food item in the compartment, or the identification of a person for whom a food product inside the compartment was made and is being stored.

The most common use for the food holding cabinet shown in the figures is as a heated cabinet wherein each of the compartments 23 maintains a separate temperature, elevated relative to room temperature, by way of electric heating elements formed in, attached above or mounted below the compartment shelves 21.

FIG. 10 shows a cross sectional view of the cabinet 10, which provides heated compartments. As shown, food items can be placed in, and removed from, either the front face 22 or the rear face 24. FIG. 10 also shows that the escutcheons on the front face have a corresponding escutcheon on the opposite face. Each escutcheon is therefore considered to have an opposing escutcheon on the opposite side.

Heat can be provided to the compartments 23 using electrically resistive heating elements 50 thermally coupled to a shelf 21.

The foregoing description is for purposes of illustration only. Those of ordinary skill in the art will recognize that while the tabs 52 depicted in the figures are on the escutcheon 26 and the detents 54 are shown formed in the chassis sides, an alternate and equivalent embodiment reverses the location of the tabs and detents such that the tabs are formed into the chassis sides and detents are formed into the escutcheons. The true scope of the invention is set forth by the appurtenant claims.

What is claimed is:

1. A temperature-controlled food holding cabinet (food holding cabinet) comprised of:
a chassis having first and second sides and front and rear sides, at least one of the front and rear sides having an opening to insert a food product into the food holding cabinet;
an escutcheon attached to the chassis and extending at least part way across one of the front and rear sides, the escutcheon having first and second opposing ends and attached to the chassis by the engagement of a tab with a detent.

2. The food holding cabinet of claim 1, wherein the tab is a protuberance extending from the escutcheon and the chassis is comprised of a detent, the detent being sized, shaped and arranged to receive the tab.

3. The food holding cabinet of claim 2, wherein the tab is proximate the first end of the escutcheon and wherein the detent is formed into a part of the chassis corresponding to the first side of the chassis.

4. The food holding cabinet of claim 2, wherein the chassis is formed to include the tab and wherein the escutcheon is formed to include the detent, the detent in the escutcheon being sized shaped and arranged to receive the tab.

5. The food holding cabinet of claim 1, wherein the escutcheon is further comprised of a user interface device and a first electrical connector, and wherein the chassis is further comprised of a second electrical connector, the first electrical connector engaging the second electrical connector when the tab engages the detent, the first and second electrical connectors providing an electrical signal pathway between the user interface device and a computer in the food holding cabinet.

6. The food holding cabinet of claim 1, wherein the chassis has a first width substantially equal to the distance between the first and second sides and wherein the escutcheon has a second width less than the first width, the escutcheon being configured to extend horizontally across the front side, proximate the opening.

7. The food holding cabinet of claim 1, wherein the tab and detent are sized, shaped and arranged to engage each other with an interference fit.

8. The food holding cabinet of claim 1, wherein the tab and detent are sized, shaped and arranged to engage each other with a clearance fit.

9. The food holding cabinet of claim 1, wherein the tab and detent are sized, shaped and arranged to engage each other with a transition fit.

10. The food holding cabinet of claim 1 further comprised of an elongated end cap along one side of the cabinet, the elongated end cap being configured to cover the tab and detent and fix the escutcheon in place.

11. The food holding cabinet of claim 1, wherein the chassis is comprised of at least one temperature-controlled compartment, and wherein the escutcheon is comprised of a user interface device to display at least one of:
a desired temperature of the at least one compartment;
an actual temperature of the at least one compartment;
an amount of time that a food item has been inside the at least one compartment;
an amount of time that a food item inside a compartment, should remain inside the compartment;
the identity of a food item inside the at least one compartment; and
identification of a person for whom a food product inside the at least one compartment, was made.

12. The food holding cabinet of claim 11, wherein the temperature controlled compartment is comprised of a shelf, said shelf being subdivided into at least first and second temperature controlled zones.

13. The food holding cabinet of claim 12, wherein the first and second temperatures controlled zones are separated by a thermal break.

14. The food holding cabinet of claim 11, wherein the user interface device is comprised of at least one of:
a keypad;
a switch;
a liquid crystal display;
at least one light emitting diode;
E-paper; and
a biometric sensor.

15. The food holding cabinet of claim 11, wherein the at least one temperature-controlled compartment is a heated compartment.

16. A temperature-controlled food holding cabinet (food holding cabinet) comprised of:
a chassis having first and second sides and front and rear sides, the front and rear sides having an opening to insert a food product into the food holding cabinet;
a first escutcheon attached to the front side of the chassis and extending at least part way across the front side, the first escutcheon having first and second opposing ends and attached to the chassis front side by the engagement of a first tab with a first detent; and
a second escutcheon attached to the rear side of the chassis, opposite the first escutcheon and extending at least part way across the rear side, the second escutcheon having first and second opposing ends and attached to the chassis rear side by the engagement of a second tab with a second detent.

17. The food holding cabinet of claim 16, wherein the first and second tabs are protuberances extending from corresponding first and second escutcheons, wherein the chassis front side is comprised of a first detent and wherein the chassis rear side is comprised of a second detent, the first and second detents being sized, shaped and arranged to receive the corresponding first and second tabs.

18. The food holding cabinet of claim 16,
wherein the first escutcheon is further comprised of a first electrical connector and, the front side of the chassis is further comprised of a second electrical connector, the first electrical connector engaging the second electrical connector when the first tab engages the first detent, the first and second electrical connectors providing an electrical signal pathway between a user interface device attached to the first escutcheon and a computer in the chassis; and
wherein the second escutcheon is further comprised of a third electrical connector and the chassis rear side is further comprised of a fourth electrical connector, the third electrical connector engaging the fourth electrical connector when the second tab in the second escutcheon engages the second detent, the third and fourth electrical connectors providing an electrical signal pathway between a user interface device attached to the second escutcheon and a computer in the chassis.

19. The food holding cabinet of claim 16, wherein the first and second escutcheons are interchangeable and usable on the front and rear sides.

20. The food holding cabinet of claim 16, wherein the chassis has a first width substantially equal to the distance between the first and second sides and wherein the first and second escutcheons have a second width less than the first width, the first and second escutcheons being configured to extend horizontally across the front and rear side, proximate the opening in the front and rear sides.

21. The food holding cabinet of claim 16, wherein the tabs and detents are sized, shaped and arranged to engage each other with an interference fit.

22. The food holding cabinet of claim 16, wherein the tabs and detents are sized, shaped and arranged to engage each other with a clearance fit.

23. The food holding cabinet of claim 16, wherein the tabs and detents are sized, shaped and arranged to engage each other with a transition fit.

24. The food holding cabinet of claim 16 further comprised of elongated caps configured to cover the tabs and detents.

25. The food holding cabinet of claim 16, wherein the user interface device is comprised of at least one of:
a keypad;
a switch;
a liquid crystal display;
at least one light emitting diode; and
E-paper.

26. The food holding cabinet of claim 16, wherein the chassis is comprised of at least one temperature-controlled compartment, and wherein at least one of the first and second escutcheons is comprised of a user interface device configured to display at least one of:
a desired temperature of the at least one compartment;
an actual temperature of the at least one compartment;
an amount of time that a food item has been inside the at least one compartment;
an amount of time that a food item inside a compartment, should remain inside the compartment;
the identity of a food item inside the at least one compartment; and
identification of a person for whom a food product inside the at least one compartment, was made.

27. The food holding cabinet of claim 16, wherein the at least one temperature-controlled compartment is a heated compartment.

28. A temperature controlled food holding cabinet comprised of:
a chassis having a top, a bottom, first and second sides and front and rear faces;
a plurality of temperature-controlled food holding compartments (compartments) within the chassis, each compartment having an opening through one of the front and rear faces and configured to receive a food product through the opening, the compartments being configured to maintain a temperature of the food product;
at least one user interface escutcheon attached to the chassis and extending at least part way across one of the front and rear faces, the escutcheon having first and second opposing ends and configured to be attached to the chassis by the engagement of a tab with a corresponding detent.

29. The food holding cabinet of claim 28, wherein the escutcheon is comprised of the tab and wherein the chassis is comprised of the detent.

30. The food holding cabinet of claim 28, wherein the chassis is comprised of the tab and wherein the escutcheon is comprised of the detent.

31. The food holding cabinet of claim 28, wherein the escutcheon is comprised of at least one of:
plastic, fiberglass and carbon fiber.

32. The food holding cabinet of claim 28, wherein the escutcheon is further comprised of a first electrical connector and the chassis is comprised of a second electrical connector, the first electrical connector engaging the second electrical connector when the tab engages the detent, the first and second electrical connectors providing an electrical signal pathway between a display device attached to the escutcheon and a computer attached to the chassis.

33. The food holding cabinet of claim 28, further comprised of a user interface device comprised of at least one of:
a keypad;
a push-button switch;
a liquid crystal display;
a light emitting diode;
E-paper;
a light bulb; and
a biometric sensor.

34. The food holding cabinet of claim 28, wherein the escutcheon is comprised of a user interface device configured to indicate at least one of:
a desired temperature inside the compartment;
an actual temperature inside a compartment;
an identity of a food product inside a compartment;
a length of time that a food product has been inside a compartment;
a length of time that a food product inside a compartment should remain inside the compartment; and
an identifier of a person for whom a food product was placed into the food holding cabinet.

35. The food holding cabinet of claim 28, wherein the tab and detent are sized, shaped and arranged to engage each other with an interference fit.

36. The food holding cabinet of claim 28, wherein the tab and detent are sized, shaped and arranged to engage each other with a clearance fit.

37. The food holding cabinet of claim 28, wherein the tab and detent are sized, shaped and arranged to engage each other with a transition fit.

38. The food holding cabinet of claim 28, further comprised of first and second end caps configured to cover the first and second ends of the user interface escutcheon and to cover the tab and detent.
